(19) United States
(12) Patent Application Publication
(10) Pub. No.: US 2010/0197484 A1
(43) Pub. Date: Aug. 5, 2010

(54) PREPARATION OF MINERAL PARTICLES IN A SUPERCRITICAL CO2 MEDIUM

(75) Inventors: Beatrice Sala, Saint Gely Du Fesc (FR); Stephanie Willemin, Montpellier (FR); Joel Mazoyer, Saint Gilles (FR); Thierry Muller, Saint Helene (FR); Nathalie Masquelez, Montpellier (FR); Didier Cot, Jacou (FR); Anne Julbe, Montpellier (FR); Pierre Guillermier, Lyon (FR)

Correspondence Address: CONNOLLY BOVE LODGE & HUTZ LLP, 1875 EYE STREET, N.W., SUITE 1100, WASHINGTON, DC, 20006, US

(73) Assignees: AREVA NP, Courbevoie (FR); CENTRE NATIONAL DE LA RECHERCHE SCIENTIFIQUE, Paris (FR)

(21) Appl. No.: 12/598,212

(22) PCT Filed: Apr. 23, 2008
(86) PCT No.: PCT/FR2008/050738

§ 371 Date: Apr. 10, 2010

(30) Foreign Application Priority Data
Apr. 30, 2007 (FR) 0754800

(51) Int. Cl. B01J 27/224; C01G 25/02; B01J 19/00; C04B 35/565; C04B 35/00

(52) U.S. Cl. 502/178; 423/608; 422/198; 501/88; 428/402; 977/773

(57) ABSTRACT

The present invention relates to a process for preparing mineral particles (p) from mineral species precursors, said process comprising a step (E) in which a fluid medium (F) containing said precursors in solution and/or dispersed in a solvent is injected into a reactor containing CO₂ in the supercritical state by way of an injection nozzle opening into a zone where the supercritical CO₂ is at a temperature greater than or equal to the temperature for conversion of the precursors into corresponding mineral species.

The invention also relates to the particles (p) as obtained by the process, as well as uses thereof.

The present invention relates to a process for obtaining mineral, millimetre-sized, particles which are also highly compact, and which have a large specific surface area. These particles, which can be easily handled and are not powdery, are especially suitable for the preparation of ceramic materials and/or catalysts, especially metal catalysts.

Numerous methods for preparing mineral particles to be used in the formation of ceramic materials and catalysts are currently known.

Within this scope, some processes employ sol/gel-type methods. This type of method is advantageously carried out in a supercritical fluid medium rather than in a liquid medium so as to avoid, especially, the use of large amounts of solvents (as well as their post-treatment which may prove problematic), and so as to also forego washing and drying of the particles obtained in order to remove any organic species. However, the processes using sol/gel-type methods in a supercritical fluid medium, such as those described for example in the work “Supercritical fluid technology in materials science and engineering, Synthesis, properties, and applications” (edited by YA-Ping Sun, Copyright Marcel Dekker, 2002), generally lead to the recovery of particles in the form of fine powders (having a typical particle size distribution of approximately a few microns) which are difficult to handle, both from a practical point of view and in terms of safety. More precisely, it is difficult to transport and treat powders of this type which are also, in fact, not easily employed in the preparation of ceramic materials, especially if they have to be mixed with other agents, in particular sintering additives. Furthermore, they are powdery by nature which means that handling them could be dangerous for the user.

Alternatively, processes have been provided which involve the preparation of powders by forming aerosols in the supercritical CO₂, for example in accordance with the method described by Jung et al. in the Journal of Supercritical Fluids, 20, 179-219 (2001). In this case, the particles are generally obtained from precursor solutions in an organic solvent, the supercritical CO₂ acting as an anti-solvent. In these processes, the supercritical CO₂ reduces the solvation capability of the solvent, resulting in supersaturation, followed by nucleation and precipitation of the desired particles. This type of process, usually known as “ASES” (Anti-Solvent Extraction System), also makes it possible to forego the washing and drying steps necessary in processes carried out in a solvent, by use of a supercritical medium. However, “ASES” processes usually lead to the formation of small particles which are in the form of powdery particles and thus exhibit the aforementioned drawbacks.

Processes are also known for preparing larger particles, especially by using supercritical CO₂. In this case, crystallisation or chemical reaction processes in supercritical CO₂ have been suggested for example, these processes being able to yield slightly larger particles than those obtained with the processes mentioned above, that is to say particles which are generally approximately one hundred microns in size. In particular, re-crystallisation of cyclotrimethylenenitramine in supercritical CO₂, leading to particles which may be approximately 150 to 200 microns in size has been described by Gallagher et al. in the Journal of Supercritical Fluids, 5, 130-142 (1992). Application FR 2 763 258 discloses the preparation of metal oxide particles by reacting metal precursors in supercritical CO₂ and then reducing CO₂ levels, which may lead in some cases to larger particles. However, in the case of the particles obtained in accordance with this type of process, high internal porosity is created which leads to the formation of cavities, the porosity being all the more pronounced, the larger the particle formed. This phenomenon is likely to be caused by the formation of an outer shell during formation of the particle, said shell trapping solvent or degradation products in the particle. The presence of cavities of this type, which adversely affects the compactness of the particle, has proven to be particularly detrimental since the particles are to be used in the formation of dense ceramics of the type used, for example, for nuclear fuel. In fact, these defects (porosities) will appear during sintering if there is bad initial stacking.

One aim of the present invention is to provide means for inhibiting, as far as possible, the aforementioned drawbacks of the formation of cavities in these particles so as to obtain large mineral particles, that is to say particles which are at least approximately a few hundred microns in size, even approximately one millimetre, approximately ten millimetres or more, but which still exhibit a very good level of compactness. In this scope, the invention aims at providing a process which is preferably beneficial in terms of reducing the amount of organic solvents used and the amount of effluents produced within a context of sustainable development.

To this end, according to a first aspect, the present invention provides a new process for preparing particles from precursors, carried out in a supercritical CO₂ medium.

More precisely, in this scope, one subject-matter of the present invention is a process for preparing mineral particles (p) from mineral species precursors, said process comprising a step (E) in which a fluid medium (F) containing said precursors in solution and/or dispersed in a solvent (S) is injected into a reactor containing CO₂ in the supercritical state, the medium (F) being injected into the reactor by way of an injection nozzle opening into a zone of said reactor where the supercritical CO₂ is at a temperature greater than or equal to the temperature for conversion of the precursors into corresponding mineral species.

Under the conditions of step (E) of the process of the invention, the mineral species precursors present in the medium (F) are converted into mineral species as soon as the medium (F) is introduced into the supercritical medium. This conversion especially involves, a vaporisation and/or decomposition of the precursors. The fact that these events take place directly at the nozzle outlet and not at a later time makes it possible to inhibit (or even avoid completely in some cases) the formation of cavities observed in the processes of the prior art. In fact, with the process of the invention, the particles are immediately mineralised at the nozzle outlet and there is a substantial elimination of mineral species precursors and their decomposition products which is also accompanied by an elimination of other organic species which may be present in the medium (F), such as organic solvents which are also vaporised and/or decomposed under the conditions of step (E). Any water which may be present in the medium (F) is also eliminated. The decomposition products of the precursors (and optionally water, organic solvents and/or their decomposition products) are thus immediately removed at the nozzle outlet and therefore do not remain trapped inside the particles being formed, contrary to currently known processes in which the precursors only decompose at a later stage in the particle during progressive mineralisation.

Hence, the process of the invention enables the preparation of particles which are substantially free of internal cavities, which leads to increased particle compactness. This compactness is reflected by the relative density of the particles obtained, which is calculated by way of the ratio of the apparent density of the particles in relation to the nominal density of the material forming the particle (that is to say the density which the material would have if it were free of cavities). The particles obtained by the process of the invention typically have a relative density greater than 50%, even if the synthesised particles are large, for example larger than 500 microns, for example approximately a few millimetres in size. The size of the synthesised particles is easily controlled by adjusting the diameter of the outlet of the nozzle used in step (E).

The process of the invention also maintains the advantages associated with the use of a supercritical CO₂ medium, in particular minimising the amount of solvent to be used in the medium (F) and offering the possibility of easily recycling the CO₂, with a considerable reduction in liquid and gaseous effluents which translates in particular into reduced process costs.

Other aspects and embodiments of the process of the invention will now be described in greater detail.

In the meaning of the present description, the expression “fluid medium” refers to a liquid or pasty medium having a viscosity which is low enough for it to be injected by way of an injection nozzle.

Generally, the fluid medium (F) used in step (E) of the process of the invention comprises:

compounds in solution in the solvent (S), these compounds in solution possibly including, inter alia, all or some of the mineral species precursors; and/or

solid objects (especially colloids, particles or particle aggregates) in suspension, stable or otherwise, in the solvent (S), these objects in suspension possibly containing all or some of the mineral species precursors.

According to a specific embodiment of the process of the invention, the fluid medium (F) used in step (E) is a medium which is organic in nature. This means that the medium (F) comprises, among other possible constituents, one or more organic compounds, these organic compounds generally being present in a significant amount in said medium and typically represent at least 25% by weight, based on the total weight of the medium (F), possibly at least 50% or even 90% in some cases.

Furthermore, in step (E) of the process of the invention, it is usually preferred if the fluid medium (F) is in gelified form when it is introduced into the reactor. The gelification of the medium (F) required in accordance with this embodiment may be carried out prior to its introduction into the reactor. Alternatively, the medium (F) may be gelified in situ at the injection nozzle.

The solvent (S) present in the medium (F) may be water, an organic solvent or a mixture of water and organic solvent (a hydroalcoholic medium in particular). If the solvent (S) is or comprises an organic solvent, said organic solvent is advantageously a compound containing a limited number of carbon atoms (typically less than 6, for example from 1 to 4 and preferably from 1 to 3), and it is typically an alcohol. In particular, ethanol is an organic solvent which is suitable as a solvent (S) in the medium (F). Methanol, formol, isopropanol, propanol or even butanol, acetylacetone, glycerol or organic acids may also be used.

In addition, in the meaning of the present description, the expression “mineral species precursor” refers to an organic or mineral compound able to convert, when subjected to thermal treatment, into a mineral species suitable for the formation of a mineral particle, generally by way of thermal decomposition.

A mineral species precursor in the meaning of the present invention may thus be, especially:
at least one organic species (in particular of the organometallic or more generally organomineral type) which, under the conditions of step (E), is converted into a mineral species constituting all or some of the particles (p); and/or
at least one mineral species which, under the conditions of step (E), is converted into another mineral species, this other mineral species constituting all or some of the particles (p).

Usually, the precursors present in the medium (F) are, or comprise metal hydroxides, mineral alkoxides (metal alkoxides or silicon alkoxides) which may be hydrolysed in part, metal oxides, metal salts or even organometallic compounds which can be thermally converted into mineral species.

A particle precursor as used in step (E) of the process of the invention may be soluble or insoluble in supercritical CO₂. According to an advantageous embodiment of the invention, all or some of the mineral species precursors used in step (E) are insoluble in supercritical CO₂.

The mineral species precursors used in step (E) are not constituents, as such, of the particles (p). They are species which are transformed into a mineral constituent of the particles (p) when they are introduced into the supercritical medium, this transformation being achieved, in particular, under the influence of temperature.

According to a specific embodiment of the invention, the medium (F) of step (E) may optionally comprise, in addition to the aforementioned mineral species precursors, preformed mineral constituents, for example in the form of mineral particles such as metal oxide particles, metal salt particles or metal particles, which are not converted into other mineral species during step (E). According to this embodiment, these preformed mineral constituents are finally incorporated into the particles obtained by the process of the invention, which therefore comprise two types of constituent—said preformed mineral species and the mineral species formed from mineral species precursors. According to this embodiment, the preformed mineral constituents are preferably introduced into the medium (F) in the form of particles which are a few nanometres in size, typically from 2 to 100 nm, for example from 5 to 50 nm in size.

Generally, the medium (F) used in step (E) may thus advantageously be a solution of mineral species precursors in the solvent (S), this solution optionally also comprising preformed mineral constituents, typically in the form of dispersed solid particles. The process of the invention thus makes it possible to adjust the composition (and consequently the functionality) of the synthesised particles (p) to a fairly large extent.

If mineral species precursors and preformed mineral compound particles are simultaneously used in the medium (F), particles (p) of a composite nature are ultimately obtained, comprising preformed mineral compound particles in a mineral matrix as a result of the conversion of the mineral species precursor, the particles of the preformed mineral constituent generally being dispersed homogeneously within the mineral matrix.

One of the practical benefits of the process of the invention is the possibility of obtaining composite particles of this type, into which virtually any type of preformed mineral particles can be introduced, thus making it possible to alter the functionality of the particles obtained over a very wide range. In this respect, it is possible to alter, inter alia, the thermal conductivity or even the electric or catalytic properties of the particles obtained and thus adapt them to different applications.

The aforementioned composite particles have another specific benefit within the field of preparation of ceramics based on a plurality of materials. More precisely, taking into account their specific structure, in which particles are dispersed homogeneously within a mineral matrix, they make it possible to obtain, by way of sintering, ceramics containing a homogeneous dispersion of one phase in another, this being achieved much more effectively than with conventional processes, in which a plurality of powders are mixed, resulting in dispersions being obtained which are neither optimal nor homogeneous.

Most often, in the process of the invention, all or some of the mineral species precursors used in step (E) are precursors which are of an organic nature, for example alkoxides, metal salts of organic anions (citrates or acetates for example) or organometallic compounds.

According to an especially advantageous embodiment of the invention, the mineral species precursors used in step (E) are, or comprise metal-organic precursors. These metal-organic precursors are typically metal alkoxides, metal salts of organic anions or organometallic compounds, the synthesised particles (p) thus being based on mineral oxides, metals and/or metal carbonyls. These metal-organic precursors are typically based on one or more metals selected from Zr, Ce, Ni, Fe, Cr, Hf, Ti, U, Pu, Th and minor actinides, such as Np, Am and Cm.

Organic compounds of silicon may also be used as mineral species precursors in step (E). In this case, the precursors used usually are, or comprise silicon alkoxides, the synthesised particles (p) thus being silica-based.

The metal-organic precursors and the organic compounds of silicon used within the scope of the present invention advantageously have a relatively low organic content with a carbon:metal molar ration advantageously between 4 and 8, preferably less than 6 in metal-organic precursors. Similarly, in organic compounds of silicon the C/Si ratio is advantageously between 4 and 8, preferably less than 6. In organometallic compounds and in alkoxides it is preferred if each of the ligands bound to the metal comprises as few carbon atoms as possible, and advantageously if each of the ligands bound to the metal comprises at most 3 carbon atoms, and more preferably 1 or 2 carbon atoms.

According to a particularly advantageous embodiment of the invention, the mineral species precursors used in step (E) are, or comprise mineral alkoxides (that is to say metal alkoxides and/or silicon alkoxides) carrying organic chains comprising between 1 and 3 carbon atoms, preferably carrying 1 or 2 carbon atoms. These alkoxides are advantageously corresponding to the following formula (I):

M(R)ₘ (I)

wherein:
M denotes a metal, preferably selected from Zr, Ce, Ni, Fe, Cr, Hf, Ti, U, Pu, Th and minor actinides such as Np, Am and Cm; or even denotes silicon Si;
m is an integer equal to the valency of the element M; and
each of the m groups R denotes, independently:
   a hydrocarbon group containing 1 to 3 carbon atoms, preferably 1 or 2 carbon atoms, or else
   a —OR′ group where R′ denotes a hydrocarbon group containing 1 to 3 carbon atoms, preferably 1 or 2 carbon atoms,

where all or some of the groups R are preferably groups OR′.

According to an advantageous variant, each of the groups R of the alkoxides corresponding to formula (I) above is a methoxy, ethoxy, propoxy, acetylacetonate, propionate, formate or acetate group, each of these groups preferably being selected from a methoxy or ethoxy group.

According to another advantageous variant, the mineral species precursors used comprise compounds corresponding to the following formulae (Ia) and/or (Ia′):

M(OR^{a})ₘ (Ia)

and/or

R^{b}_{m′}M(OR^{c})_{m″} (Ia′)

where:
M and m are as defined above;
m′ and m″ are two non-zero integers and the sum (m′+m″) equals m;
each of the m groups R^{a}, each of the m′ groups R^{b} and each of the m″ groups R^{c} denotes, independently of the other groups present, a hydrocarbon group containing from 1 to 3 carbon atoms, preferably 1 or 2 carbon atoms.

According to a possible variant, a mixture of compounds corresponding to formula (Ia) and of compounds corresponding to formula (Ia′) is used. Alternatively, it is possible to use just compounds of formula (Ia), or even just compounds of formula (Ia′).

The precursors or particles used in step (E) are advantageously compounds corresponding to formula M(OCH₃)ₘ, M(OC₂H₅)ₘ, and/or (H₃C)_{m′}M(OCH₃)_{m″} (for example (H₃C)M(OCH₃)ₘ₋₁), where M, m, m′ and m″ are as defined above.

In another variant, at least one (generally one, or even two) of the groups —R of alkoxides of formula (I) is a carboxy group containing from 1 to 3 carbon atoms. This group is advantageously a —OC(═O)—CH₃ or OC(═O)—CH₂—CH₃ group, the other groups —R thus advantageously being methoxy or ethoxy groups, it being understood that at least one of the groups —R is preferably an methoxy or ethoxy group.

It is possible, irrespective of the exact nature of the medium (F) and the precursors used, to alter the morphology of the particles (p) in step (E) by adapting the way in which the medium (F) is introduced into the supercritical CO₂. In fact, the morphology of the particles (p) is dictated by the shape of the medium (F) as it issues from the injection nozzle.

Hence, in a first possible embodiment, the medium (F) can be injected dropwise into the reactor containing CO₂ in the supercritical state, the particles obtained being generally spherical. For this purpose, a power reactor which is longer than or equal to 10 cm is typically used as the reactor. The dropwise introduction method is typically carried out using a nozzle provided with a pulsed valve.

In another conceivable embodiment, the medium (F) is injected in continuous sequences into the reactor containing CO₂ in the supercritical state, the particles obtained thus being in the shape of substantially cylindrical rods of variable length. Within the scope of this variant, it is possible to alter the injection rate, the injection pulse frequency and the viscosity of the medium (F) to increase the length of the rods obtained.

Other shapes of the particles (p) are also possible, in particular by altering the shape of the injection nozzle, the injection rate and the length of the tower reactor.

Irrespective of the desired shape of the particles (p), it is usually desirable to allow the particles to develop within the supercritical CO₂ following thermal degradation at the nozzle outlet before bringing them into contact with one another, in particular to prevent inter-particle adhesion or coalescence. This is particularly applicable when spherical particles are desired. For this purpose, the medium (F) is preferably introduced into the upper portion of a reactor, thus allowing the forming particle to fall over a height of at least a few centimetres, preferably generally over a height of at least 10 cm. For example, it is possible to inject the medium (F) into the upper portion of a tubular reactor which has a length of from a few tens of centimetres to a few metres (typically of from 10 cm to 10 m, said length advantageously being at least 50 cm, or even at least 1 m, for example between 2 and 5 m) and is full of CO₂ in the supercritical state, the particles formed, after the thermal decomposition of the mineral species precursors in the proximity of the injection nozzle, falling to the bottom of the reactor and thus remaining in contact with the supercritical CO₂ for a sufficient period of time to prevent the aforementioned problems.

More generally, irrespective of the nature of the mineral species precursors present in the medium (F), the concentration of these precursors is preferably as high as possible, and this in particular enables the amount of solvent used in the medium (F) to be reduced. In this respect, it is generally preferable for the concentration of mineral species precursors in the medium (F) to be at least 0.01 mol of metal M per litre, and advantageously at least 0.1 mol of metal per litre, for example between 0.5 and 10 mol of metal M per litre.

The temperature of the zone into which the nozzle used in step (E) to inject the medium (F) opens depends on the exact nature of the compounds (precursors but also other optional organic compounds) present in the medium (F), the temperature increasing with the extent to which the compounds present are able to resist thermal degradation. In order to carry out step (E) effectively, it is usually advantageous for the injection nozzle via which the medium (F) is injected to open into a zone which is at a temperature between 120 and 500° C., preferably between 150 and 400° C., and typically approximately 200° C. This temperature range generally allows a good degree of conversion of the mineral species precursors at the nozzle outlet without causing calcination of the synthesised particles, and this generally enables particles formed of grains which are close to crystallisation or are crystallised in some cases to be obtained. Furthermore, the formation of a solid gel around the forming particle, which could inhibit CO₂ diffusion, is not observed in the aforementioned preferred temperature ranges. For efficient injection, the nozzle itself is generally cooled (typically to less than 200° C., for example to less than 100° C.), in particular to prevent premature conversion of the precursors in the medium (F) within the nozzle itself. It is also possible to provide a flow of inert gas such as helium in the region of the injection nozzle, in particular to prevent supercritical CO₂ from penetrating into the nozzle, which could cause the particles to precipitate at the nozzle outlet.

The structure of the nozzle, especially the outlet diameter thereof, is to be adapted to the size and shape of the desired particles (p). According to the invention, it is possible to use nozzles having an outlet diameter of approximately a few millimetres, typically approximately from 1 to 5 mm, generally 2 to 4 mm, thus producing large particles which are typically greater than 500 microns and can reach several millimetres in size, very few cavities appearing within the particles obtained.

The process according to the invention may advantageously comprise a step of thermally treating the particles formed at the nozzle outlet, which step can be carried out subsequently or simultaneously to step (E) and enables consolidation or even densification of the particles formed to take place. A thermal treatment of this type is advantageously carried out at a temperature greater than or equal to 1,200° C., for example greater than or equal to 1,500° C. (typically in the region of 1,600° C. if the synthesised particles are based on compounds of metals such as zirconium and full densification is desired).

Moreover, it should be noted that the process according to the invention can be carried out equally well in a discontinuous mode as in a continuous mode.

According to a more particular aspect, the present invention also relates to a device for carrying out the process according to the invention.

This device typically comprises a reactor which is suitable for the use of supercritical CO₂, and comprises:
an injection chamber provided with an injection nozzle suitable for carrying out step (E), said injection chamber being provided with means for heating to a temperature of between 120 and 500° C., preferably between 150 and 400° C. (typically approximately 200° C.);
means for recovering the particles formed in the reactor.

This device preferably further comprises, between the injection chamber and the recovery means, a reaction zone provided with heating means able to keep the CO₂ in supercritical conditions, preferably at a temperature of between 120 and 500° C., for example between 200 and 500° C., suitable for the formation of particles.

An increasing temperature gradient is advantageously established in this device in the reaction zone between the injection chamber and the means for recovering the particles, in particular to prevent thermal shocks.

According to an especially beneficial embodiment, a device useful according to the invention is in the form of a vertical reactor (for example a tubular tower reactor) comprising the injection nozzle at an upper level and the means for recovering the particles at a lower level, the reaction zone thus extending from said upper level to said lower level.

According to a further aspect, the invention relates to the original particles as obtained by the process of the invention.

These particles are usually larger than 150 microns, even larger than 200 microns, advantageously between 500 microns and 2 mm, in size and have a relative density generally greater than 50%, which indicates that cavities are substantially absent from the interior of the particles.

These particles are generally in the form of aggregates of nanograins, thus giving the particles a generally high specific surface area. In general, the BET specific surface area of the particles as obtained according to the invention is greater than 100 m²/g, preferably greater than or equal to 200 m²/g. This is typically the case for amorphous ZrO₂ particles. In the meaning of the present description, the term “specific surface area” refers to the BET specific surface area as determined via nitrogen adsorption by the well known method, known as the BRUNAUER-EMMET-TELLER method which is described in The Journal of the American Chemical Society, volume 60, page 309 (1938) and corresponds to international standard ISO 5794/1.

Furthermore, the particles (p) obtained by the process of the invention are generally substantially free of organic compounds and typically comprise less than 0.1%, or even less than 0.05% by weight of organic compounds.

Furthermore, the particles (p) obtained according to the invention are generally based on at least one metal oxide, at least one metal in the metallic state and/or at least one metal carbonyl. In a beneficial embodiment, the particles are based on mineral oxide, generally based on metal oxide or silica.

Most generally, the particles obtained according to the invention have been found to be suitable for the efficient preparation of ceramic material. In this respect, they lend themselves particularly well to shaping and sintering processes in which their relatively large size enables them to be handled more easily. The high compactness thereof also enables high quality ceramic material to be obtained. The invention also relates to the ceramic materials obtained in this way. These ceramic materials are typically in the form of bars, tubes, plates or membranes, for example in the form of membranes suitable for use in a fuel cell or an electrolysis device or membranes suitable for separating liquids and/or gases.

In a specific embodiment, the particles (p) formed in the process according to the invention are zirconium-oxide-based particles.

The zirconium-oxide-based particles (p) are advantageously obtained from organic zircon-based precursors such as zirconium alkoxides, for example from a zirconium ethoxide advantageously modified by an organic acid such as HCOOH and preferably dissolved in nitric acid. Alternatively, zirconium-oxide-based particles (p) may be obtained from a zirconium hydroxide.

In a specific embodiment, the zirconium-based particles (p) as obtained according to the invention are basically formed from ZrO₂, which typically represents at least 95% by weight, usually at least 98% by weight, or even at least 99% by weight, based on the total weight of the particle.

According to a beneficial embodiment, the zirconium-based particles (p) according to the invention are composite particles obtained from an initial medium (F) comprising, in addition to organic zircon-based precursors, preformed mineral particles based on other compounds which are dispersed homogeneously within a ZrO₂ matrix in the particles obtained. In this respect, the preformed mineral particles used, which are ultimately dispersed within the ZrO₂ matrix of the particles (p), are for example silicon carbide SiC particles, chromium boride BCr₂ particles, boron oxide B₂O₃ particles, chromium oxide Cr₂O₃ or Cr₃O₄ particles, or nickel oxide NiO particles, typically approximately 2 to 50 nm in size, or even nuclei of metal oxides, for example nuclei of metallic ZrO₂ with a typical particle size of 4 to 5 microns. The composite particles thus obtained are beneficial in particular for the formation of ceramic materials or catalysts, especially metal-based ceramic materials or catalysts in a metallic state. In particular, the use of these composite particles as a raw material in a ceramic formation process enables specific materials comprising particles, in particular metal particles in some cases, which are distributed in a ceramic porous material, to be obtained. In this respect, it is possible in particular to obtain specific materials exhibiting both ceramic characteristics and metal catalyst characteristics at the same time. In particular, the particles (p), based on ZrO₂ and including dispersed NiO particles, which can be reduced to form Ni, enable catalysts which are of great benefit, in particular for methane decomposition and re-formation in the hydrogen production process, to be obtained.

More generally, the synthesised particles according to the invention may be used to synthesise catalysts. The composite particles comprising metal particles which are dispersed in a mineral matrix (of ZrO₂ or another mineral) may be used more specifically for the preparation of a catalyst in the form of a nanoporous ceramic material comprising dispersed metal particles.

In another more specific embodiment, the particles (p) may advantageously be based on fissile or fertile material, said fissile or fertile material preferably comprising at least one element selected from U, Pu, Th, minor actinides such as Np, Am, Cm, or a mixture of these elements, the particles preferably comprising at least one of these elements in a metallic and/or oxide form. In this respect, the particles (p) may advantageously be based on uranium oxide UO₂, plutonium oxide PuO₂, thorium oxide ThO₂, or based on actinides or one of the oxides thereof, or a mixture of these materials. These specific particles (p) are suitable for use as fuel cores in a nuclear reactor or for the preparation of a fuel core for a nuclear reactor (for example a ceramic fuel core).

Alternatively, and in a non-limiting manner, the process according to the invention also enables particles (p) based on CeO₂, or else HfO₂, TiO₂, ZnO and/or SiO₂ to be obtained.

A clearer understanding of different aspects and advantages of the invention will be obtained from the illustrative examples explained below and given with reference to the appended figures, in which:

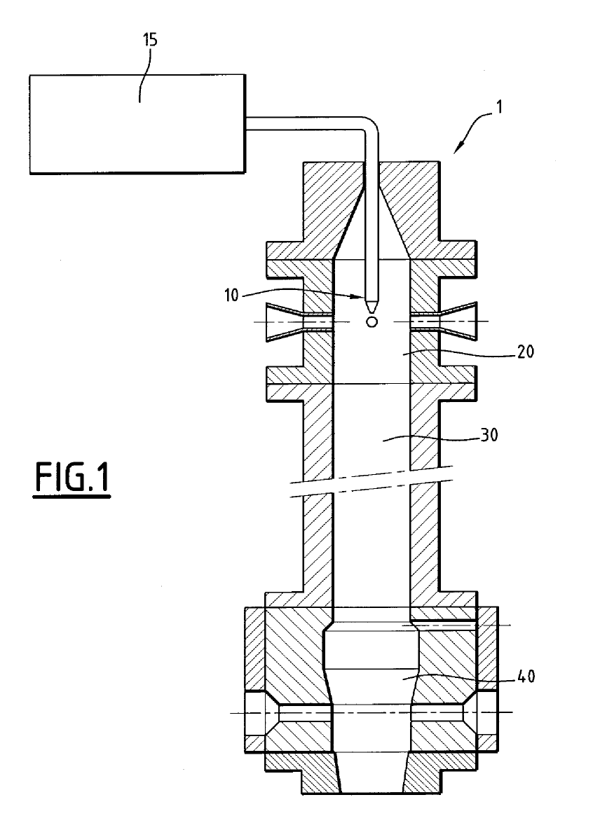

FIG. 1 is a schematic view of a device for carrying out the process according to the invention, the device being of the type used in the examples;

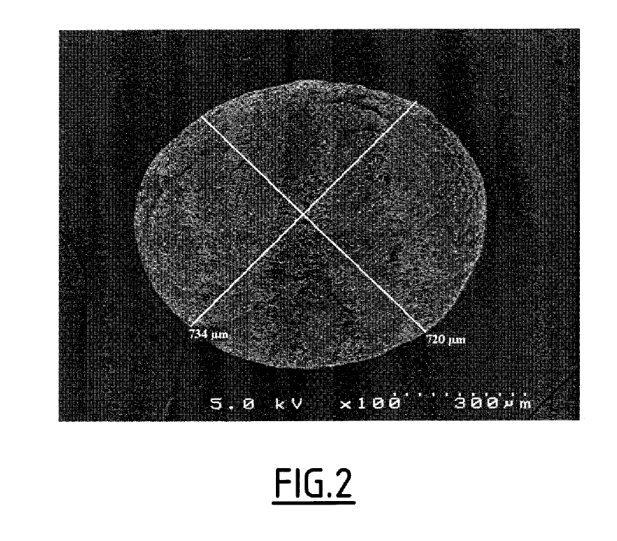

FIG. 2 is a micrograph of a particle according to the invention obtained in accordance with Example 1 below;

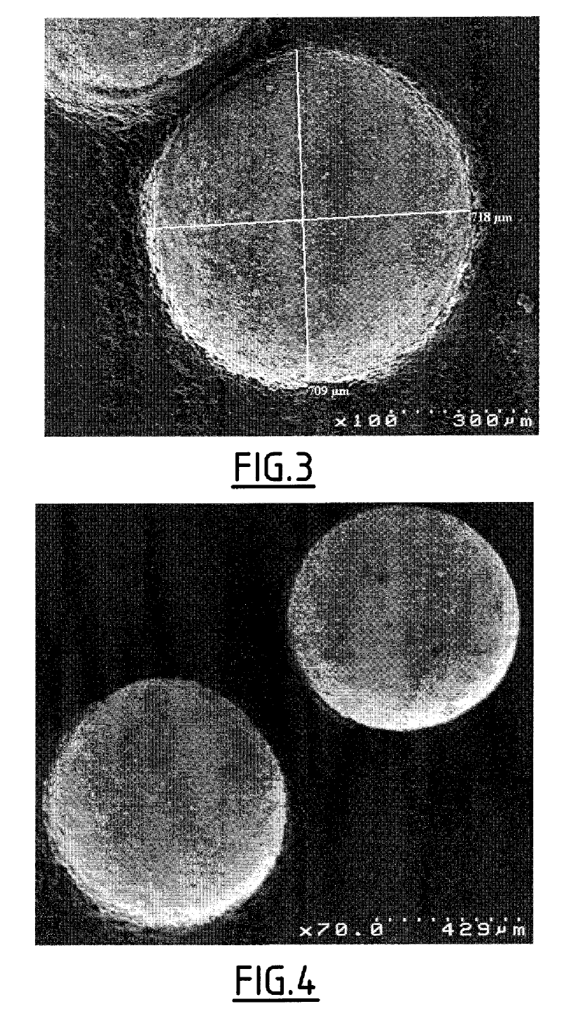

FIGS. 3 and 4 are two micrographs of particles obtained in accordance with Example 2 below, after being sintered at 1,550° C. for 6 hours; and

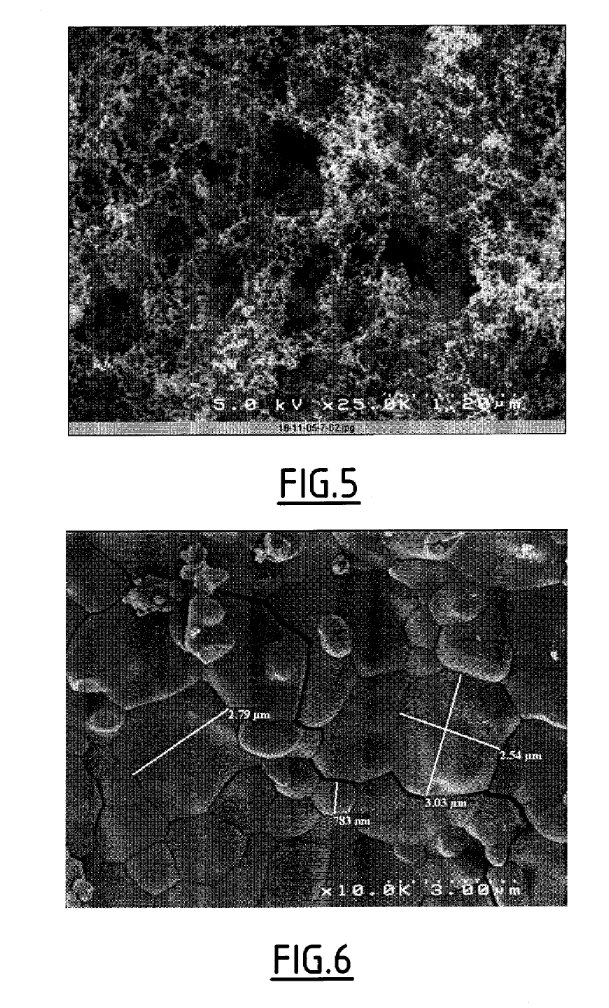

FIGS. 5 and 6 are both micrographs showing the cross-section of a particle as obtained in accordance with Example 2, before and after sintering at 1,550° C. for 6 hours respectively.

FIG. 1 shows a reactor 1 in the form of a vertical reactor which is filled with CO₂ in the supercritical state and is provided with an injection nozzle 10 at an upper level, the injection nozzle being connected to a container 15 containing the medium (F) to be injected and opening into a first zone of the reactor forming an injection chamber 20 which is provided with means for heating to a temperature of between 120 and 500° C. The mineral species precursors which are initially present in the medium (F) are instantaneously converted into mineral species in said chamber in the proximity of the nozzle outlet, the degradation products being vaporised and/or decomposed immediately at the same time, as well as water and/or any optional solvents present, thus leaving a substantially mineralised particle in the chamber 20. The particle formed falls towards the bottom of the reactor under the effect of its own weight by passing through a reaction zone 30 which is typically brought to a temperature of from 120 to 500° C., typically of from 200 to 500° C., in which the particle consolidation process is completed. Finally, the particle formed is located in the recovery chamber 40, where it is recovered from the supercritical CO₂. An increasing temperature gradient is preferably established in the reaction zone 30 between the chambers 20 and 40.

In some embodiments of the invention, the reaction chamber 30 may optionally be dispensed with, in which case a heap of powder is generally obtained in the recovery chamber 40. The presence of the reaction chamber 30 is generally required if individual ball-shaped or rod-shaped particles are desired.

Different tests were carried out in a device as shown in FIG. 1 which was provided with a tower 1 metre in length, two examples of said tests being described below.

### EXAMPLES

### Example 1

### Synthesis of a ZrO₂ Particle

### No Sintering

In this example, ZrO₂ particles were synthesised by the process of the invention from a medium (F1) prepared under the following conditions:
1.5 g zirconium ethoxide (or 5.5×10⁻³ mol) in 10 g ethanol were brought to 50° C. under reflux for 3 hours while stirring,
5.5×10⁻³ mol of formic acid were added, and then the medium was again brought to 50° C. under reflux for 30 minutes,
0.54 g HNO₃ in a 70% aqueous solution were then added to the medium obtained.

The medium (F1) obtained after these various steps was in a liquid form and had a milky appearance.

This medium (F1), which was placed in the container 15, was injected by the injection nozzle 10 at a rate of 20 ml/hour at a pulse rate of two drops per second (pulsed valve) under the following conditions:
temperature in the injection chamber 20: 200° C.;
temperature in the recovery chamber 40: 315° C.;
increasing temperature gradient between the two chambers, with a temperature of 300° C. in the reaction chamber 30;
CO₂ pressure: 110 bar;
use of helium as a cover gas in the region of the injection nozzle 10.

Dense, cavity-free, substantially spherical particles with an average diameter of approximately 700 μm were obtained at the reactor outlet. FIG. 2 is a micrograph taken at a magnification factor of 100 of a particle obtained in this way (no sintering).

### Example 2

### Synthesis of a ZrO₂ Particle Incorporating Preformed SiC Particles

In this example, particles were synthesised by the process of the invention from a medium (F2) prepared under the following conditions:
a mixture containing 3 g zirconium ethoxide (or 11×10⁻³ mol), 20 g ethanol and 0.54 g of a 70% aqueous HNO₃ solution, was brought to 50° C. under reflux for 4 hours while stirring, thus dissolving the zirconium ethoxide in the medium;
the medium was then allowed to cool to room temperature (25° C.) and 4 g water and 5.5×10⁻³ mol formic acid were subsequently added to the medium and the medium was left for an hour while being stirred;
0.019 g SiC crystals with an average diameter of 30 nanometres were added to the medium.

The medium (F2) obtained after these different steps was in the form of a polymer gel, the fluid characteristics of which depended on the duration and speed of stirring (thixotropic effect).

The medium (F2), which was placed in the container 15, was injected by the injection nozzle 10 under the same conditions as in Example 1.

At the reactor outlet, dense, cavity-free, substantially spherical particles with an average diameter of approximately 1.4 mm and morphology substantially identical to that of the preceding example, as shown in FIG. 2, were obtained before sintering. These particles had a specific surface area of 200 m²/g before sintering.

The particles were then subjected to a sintering step at 1550° C. for 6 hours, which resulted in the formation of particles as shown in FIGS. 3 and 4 (micrographs magnified ×100 and ×70 respectively).

FIGS. 5 and 6 are highly magnified micrographs (×25,000 and ×10,000 respectively) of cross-sections of particles synthesised as described in Example 2 before and after sintering respectively. These figures show the homogeneity and compactness of the particles according to the invention, as well as the absence of any cavities within the particles formed, for millimetre-sized particles (700 μm after sintering).

1-34. (canceled)

35. A process for preparing mineral particles (p) from mineral species precursors, said process comprising a step (E), wherein a fluid medium (F) containing said precursors in solution and/or dispersed in a solvent (S) is injected into a reactor (1) containing CO₂ in the supercritical state, the medium (F) being injected into the reactor (1) by way of an injection nozzle (10) opening into a zone (20) of said reactor where the supercritical CO₂ is at a temperature at least equal to the temperature for conversion of the precursors into corresponding mineral species.

36. The process of claim 35, wherein the fluid medium (F) is in gelified form when it is introduced into the reactor (1), the medium (F) being gelified prior to its introduction into said reactor (1), or in situ at the injection nozzle.

37. The process of claim 35, wherein the mineral species precursors used in step (E) are, or comprise metal hydroxides, mineral alkoxides which may be hydrolysed in part, metal oxides, metal salts or even organometallic compounds which can be thermally converted into mineral species.

38. The process of claim 35, wherein the mineral species precursors used in step (E) comprise metal-organic precursors or organic silicon compounds.

39. The process of claim 38, wherein in the metal-organic precursors the carbon metal molar ratio is between 4 and 8, and in the organic silicon compounds the Si:C molar ratio is between 4 and 8.

40. The process of claim 38, wherein the mineral species precursors used in step (E) comprise metal alkoxides, metal salts of organic anions or organometallic compounds, whereby the synthesised particles (p) are based on mineral oxides, metals in the metallic state and/or metal carbonyls.

41. The process of claim 38, wherein the mineral species precursors used in step (E) comprise silicon alkoxides, whereby the synthesised particles (p) are based on silica.

42. The process of claims 38, wherein the mineral species precursors used are mineral alkoxides carrying organic chains comprising between 1 and 3 carbon atoms.

43. The process of claim 42, wherein the mineral species precursors used comprise mineral alkoxides or mineral alkoxides mixtures corresponding to the following formula (I):
M(R)ₘ (I)
wherein:
M denotes a metal, or even silicon Si;
m is an integer equal to the valency of the element M; and
each of the m groups R denotes, independently:
a hydrocarbon group containing 1 to 3 carbon atoms, preferably 1 or 2 carbon atoms, or else
a —OR′ group where R′ denotes a hydrocarbon group containing 1 to 3 carbon atoms, preferably 1 or 2 carbon atoms.

44. The process of claim 43, wherein each of the m groups R of the alkoxides of formula (I) is a methoxy, ethoxy, propoxy, acetylacetonate, propionate, formate or acetate group.

45. The process of claim 43, wherein the mineral species precursors used comprise compounds having the following formulae (Ia) and/or (Ia′):
M(OR^{a})ₘ (Ia)
and/or
R^{b}_{m′}M(OR^{c})_{m″} (Ia′)
wherein:
M and m are as defined in claim 43;
m′ and m″ are two non-zero integers and the sum (m′+m″) equals m;
each of the m groups R^{a}, each of the m′ groups R^{b} and each of the m″ groups R^{c} denotes, independently of the other groups present, a hydrocarbon group containing from 1 to 3 carbon atoms, preferably 1 or 2 carbon atoms.

46. The process of claim 43, wherein at least one of the groups R of alkoxides of formula (I) is a carboxy group containing from 1 to 3 carbon atoms, and wherein the other groups are methoxy or ethoxy groups.

47. The process of claim 35, wherein the medium (F) is injected dropwise into the reactor containing CO₂ in the supercritical state, whereby the particles obtained are substantially spherical.

48. The process of claim 35, wherein the medium (F) is injected in continuous sequences into the reactor containing CO₂ in the supercritical state, the whereby particles obtained are rod-shaped.

49. The process of claim 35, wherein the concentration of precursors in the medium (F) is at least 0.01 mol of metal per litre of medium (F).

50. The process of claims 35, wherein the injection nozzle via which the medium (F) is injected opens into a zone which is at a temperature between 120 and 500° C.

51. The process of claims 35, wherein the medium (F) comprises, in addition to mineral species precursors, preformed mineral constituents which are incorporated into the synthesised particles.

52. A device useful for carrying out a process according to claim 35, comprising a reactor suitable for the use of supercritical CO₂, and comprising:
an injection chamber (20) provided with an injection nozzle (10) suitable for carrying out step (E), said injection chamber being provided with means for heating to a temperature between 120 and 500° C., preferably between 150 and 400° C.; and
means (40) for recovering the particles formed in the reactor.

53. The device of claim 52, further comprising between the injection chamber (20) and the recovery means (40), a reaction zone (30) provided with heating means which are able to keep the CO₂ in supercritical conditions, preferably at a temperature between 120 and 500° C., for example between 200 and 500° C., suitable for the formation of particles.

54. The device of claim 53, wherein a temperature gradient is established which increases in the reaction zone (30) between the injection chamber (20) and the means (40) for recovering the particles.

55. The device of claim 53, in the form of a vertical reactor (1) comprising the injection nozzle (10) at an upper level and the means (40) for recovering the particles at a lower level, the reaction zone (30) extending from said upper level to said lower level.

56. Mineral particles as obtained by a process comprising a step (E) wherein a fluid medium (F) containing said precursors in solution and/or dispersed in a solvent (S) is injected into a reactor (1) containing CO₂ in the supercritical state, the medium (F) being injected into the reactor (1) by way of an injection nozzle (10) opening into a zone (20) of said reactor where the supercritical CO₂ is at a temperature at least equal to the temperature for conversion of the precursors into corresponding mineral species.

57. The mineral particles of claim 56, which are greater than 150 microns in size and have a relative density greater than 50%.

58. The mineral particles of claim 56, which have a BET specific surface area greater than 100 m²/g.

59. The particles of claims 56, which are substantially free of organic compounds.

60. The particles of claims 56, which are particles based on mineral oxide, in particular particles based on metal oxide or silica.

61. The particles of claim 60, wherein the particles are based on zirconium oxide ZrO₂.

62. The particles of claims 56, based on uranium oxide UO₂, plutonium oxide PuO₂, thorium oxide ThO₂, actinides or one of their oxides, or a mixture of these materials.

63. A ceramic material obtained by the shaping and sintering of the particles of claim 56.

64. A ceramic material of claim 56, which is in the form of a bar, tube, plate or membrane.

65. A catalyst including the particles of claim 56.

66. A catalyst in the form of a nanoporous ceramic material comprising dispersed metal particles, obtained from particles according to claim 56 which are composite particles comprising metal particles dispersed in a mineral matrix.

67. Fuel core for a nuclear reactor consisting in or comprising particles according to claim 62, or a ceramic material obtained from said particles.
